(19) United States
(12) Patent Application Publication
(10) Pub. No.: US 2015/0296369 A1
(43) Pub. Date: Oct. 15, 2015

(54) Handling of Subscriber Identity Module (SIM) Cards with Multiple Profiles

(71) Applicant: QUALCOMM Incorporated, San Diego, CA (US)

(72) Inventors: Michele Berionne, San Diego, CA (US); Tze Kwan Lau, San Diego, CA (US); Kiran Kuman Vemareddy, San Diego, CA (US)

(21) Appl. No.: 14/676,081

(22) Filed: Apr. 1, 2015

Related U.S. Application Data
(60) Provisional application No. 61/979,399, filed on Apr. 14, 2014.

(51) Int. Cl. H04W 8/18

(52) U.S. Cl. CPC H04W 8/183

(57) ABSTRACT

Various embodiments provide methods implemented on a mobile communication device for generating a database of information associated with a plurality of profiles associated with a SIM installed in the mobile communication device in order to enable the device to efficiently switch between profiles by utilizing the information stored in the database. In various embodiments, the mobile communication device may populate the profile database with information, data, and/or values needed to acquire service/camp on a network for each of a plurality of profiles associated with the SIM by activating each profile, collecting such service information associated with each activated profile, and storing the service information in the profile database for use in switching between the plurality of profiles at a later time. Specifically, by using information already determined to be relevant to and/or necessary for acquiring service with a profile, the mobile communication device may switch to that profile quickly.

### CROSS REFERENCE TO RELATED APPLICATIONS

This application claims the benefit of priority to U.S. Provisional Patent Application No. 61/979,399 entitled “Handling of SIM Card with Multiple Profiles” filed Apr. 14, 2014, the entire contents of which are incorporated herein by reference.

### BACKGROUND

Currently, mobile communication devices—such as smart phones, tablet computers, and laptop computers—typically include a Subscriber Identity Module (SIM) card that includes a profile that is associated with information about the device's user, such as the user's preferences, settings, and other types of servicing information that are exchanged with a mobile network to permit the mobile communication device to acquire service. For example, a SIM's profile usually includes the mobile communication device's international mobile subscriber identity or “IMSI” that is sent a mobile network, which uses the IMSI (among other profile information) to identify the user associated with the IMSI and to determine whether to provide service/access to that particular user. In another example, the profile may include information about the identity of the public land mobile network (“PLMN”), and the mobile communication device may use this information when looking for the correct mobile network to receive service.

Some new designs of mobile communication devices include SIM cards that are each associated with multiple profiles. In such devices, one profile is active while the other profiles are inactive, but the mobile communication device is able to disable the currently active profile and activate another profile (i.e., switch profiles) on the SIM to enable the mobile communication device to receive service using another profile. In other words, a first profile may include information that, when exchanged with a first mobile network, enables the mobile communication device to receive service from that first mobile network, and after switching to a second profile, the mobile communication device may similarly exchange information with and receive service from a second mobile network. In a further example, the first profile may be used to receive service while a user is in a home network, whereas the second profile may be useful in receiving service from a second network when the user leaves the home network area.

### SUMMARY

Various embodiments provide methods, devices, and non-transitory processor-readable storage media for managing service information for a plurality of profiles associated with a Subscriber Identity Module (SIM) on a mobile communication device. Some embodiment methods may include initializing a first profile database stored in memory of the mobile communication device, activating and collecting service information for each of the plurality of profiles, and storing the collected service information associated with each of the plurality of profiles in the first profile database.

In some embodiments, the method may further include associating the stored first profile database with the SIM on the mobile communication device. In some embodiments, the method may further determining whether there is a preferred profile in the plurality of profiles based on the collected service information in the first profile database stored in memory of the mobile communication device, initiating a switch to the preferred profile from an active profile in response to determining that there is a preferred profile in the plurality of profiles based on the collected service information stored in the first profile database.

In some embodiments, the method may further include detecting when a new SIM is installed in the mobile communication device, determining whether there is a profile database associated with the new SIM that is stored in memory of the mobile communication device, and loading the stored profile database associated with the new SIM in response to determining that there is a profile database associated with the new SIM that is stored in the memory of the mobile communication device. In such embodiments, the method may further include initializing a second profile database in response to determining that there is no profile database associated with the new SIM that is stored in the memory of the mobile communication device, identifying a plurality of profiles associated with the new SIM, activating and collecting service information for each of the plurality of profiles associated with the new SIM, and storing the collected service information associated with each of the plurality of profiles associated with the new SIM in the second profile database in the memory of the mobile communication device.

In some embodiments, the method may further include acquiring service using an active profile in the plurality of profiles, accessing service information associated with the non-active profile that is stored in the profile database, and initiating a switch to the non-active profile from the active profile by using the accessed service information associated with the non-active profile. In such embodiments, the method may further include updating service information associated with the active profile that is stored in the profile database stored in the memory of the mobile communication device. In some embodiments, the method may further include performing background scans for the non-active profile to obtain background scan information associated with the non-active profile, where initiating a switch to the non-active profile from the active profile by using the accessed service information associated with the non-active profile includes initiating the switch to the non-active profile from the active profile by using at least one of the accessed service information associated with the non-active profile and the background scan information associated with the non-active profile. In some embodiments, determining whether a profile switch from the active profile to a non-active profile has been initiated may further include accessing service information included in the profile database for each of the plurality of profiles, displaying the plurality of profiles with the service information for each of the plurality of profiles, determining whether a selection of a displayed profile associated with a non-active profile in the plurality of profiles has been received, accessing service information associated with the selected non-active profile from the profile database stored in the mobile communication device, and initiating a switch from the active profile to the selected non-active profile.

In some embodiments, the service information may include at least one of an international mobile subscriber identity, an allowed public land mobile network, a forbidden public land mobile network, a service provider name, a mobile network name, a neighboring cell, a frequency band, and service agreement information.

Various embodiments may include a computing device configured with processor-executable instructions to perform operations of the methods described above.

Various embodiments may include non-transitory processor-readable media on which is stored processor-executable instructions configured to cause a processor of a mobile communication device to perform operations of the methods described above.

Various embodiments may include a computing device having means for performing functions of the operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features disclosed herein.

FIG. 1 is a communication system block diagram of mobile telephony networks suitable for use with various embodiments.

FIG. 2 is a component block diagram of a mobile communications device according to various embodiments.

FIG. 3 is a process flow diagram illustrating a method for generating a profile database that includes information associated with a plurality of SIM profiles according to various embodiments.

FIG. 4 is a process flow diagram illustrating a method for loading a profile database stored in memory in response to detecting that a new SIM is installed in the mobile computing device and associated with the stored profile database according to various embodiments.

FIG. 5 is a process flow diagram illustrating a method for utilizing a profile database when initiating switches from an active profile to a non-active profile according to various embodiments.

FIG. 6 is a process flow diagram illustrating a method for displaying information stored in a profile database to enable a user to initiate a switch from an active profile to a non-active profile according to various embodiments.

FIG. 7 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As used herein, the term “mobile communication device” refers to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include a programmable processor, memory, and circuitry for connecting to at least two mobile communication networks. The various aspects may be useful in mobile communication devices, such as smart phones, and so such devices are referred to in the descriptions of various embodiments. However, the embodiments may be useful in any electronic devices that may individually utilize one or more SIMs.

As described, multiple profiles associated with a SIM included in a mobile communication device may enable the device to receive service from one or more mobile networks. In a conventional mobile communication device, in order to initiate a profile switch from a first profile to a second profile, the device completely deactivates the first profile and then must fully initialize the second profile. As such, before the second profile may be used on the mobile communication device, the device must, among other things, determine the second profile, the second profile's mobile networks, and various other kinds of information needed to acquire service and/or camp on a suitable network for the second profile. As a result, current methods of switching profiles require a substantial amount of time and processing resources to reinitialize each new active profile during a profile switch.

In overview, various embodiments provide methods implemented on a mobile communication device for generating a database of information associated with a plurality of profiles associated with a SIM (i.e., a multi-profile SIM) installed in the mobile communication device in order to enable the device to efficiently switch between profiles by utilizing the information stored in the database. In various embodiments, the mobile communication device may populate the profile database with information, data, and/or values needed to acquire service/camp on a network (herein referred to generally as “service information”) for each of a plurality of profiles associated with the SIM by activating each profile, collecting service information associated with each activated profile, and storing the service information in the profile database for use in switching between the plurality of profiles at a later time. By using information already determined to be relevant to and/or necessary for acquiring service with a profile, the mobile communication device may switch to that profile more efficiently than in conventional implementations.

In some embodiments, the mobile communication device may associate the profile database with the SIM and may store the profile database and the association in memory of the device (i.e., not within the SIM). By storing the profile database and its association with the SIM within the device's memory, the mobile communication device may recall the profile database from memory in response to detecting that the SIM has been inserted in the mobile communication device. By storing the profile database and its association with the SIM within the device's non-volatile memory, the mobile communication device may recall the profile database for the SIM installed in the device from non-volatile memory when the device powers up. Thus, the mobile communication device may utilize the stored profile database rather than generating a profile database from scratch each time the same SIM is inserted in the mobile communication device or each time the device powers up.

In some embodiments, the mobile communication device may use service information included in the profile database (e.g., the PLMNs, mobile networks, and other service information) to perform background scans for the non-active profiles. In contrast to conventional mobile communication devices that use hard-coded values when performing background scans for non-active profiles, various embodiments enable the mobile communication device to use the highly relevant service information included in the profile database to enable the device to initiate comparatively efficient and fast profile switches.

In some embodiments, the mobile communication device may present a display identifying the plurality of profiles stored in the database, along with some or all of the service information stored in the database profile associated the profiles. By presenting this display of the profiles with specific service information (e.g., service agreement information, servicing mobile networks, etc.), the various embodiments enable the mobile communication device to provide the user with relevant information for each of the profiles that the user may reference when initiating a profile switch. For example, the communication device may display that a first profile (e.g., a “roaming” profile) and a second profile (e.g., a “home/domestic” profile) have different service agreements based on the current location of the mobile communication device, and the user may make an informed decision to switch from the first profile to the second profile to benefit from a better data-usage rate.

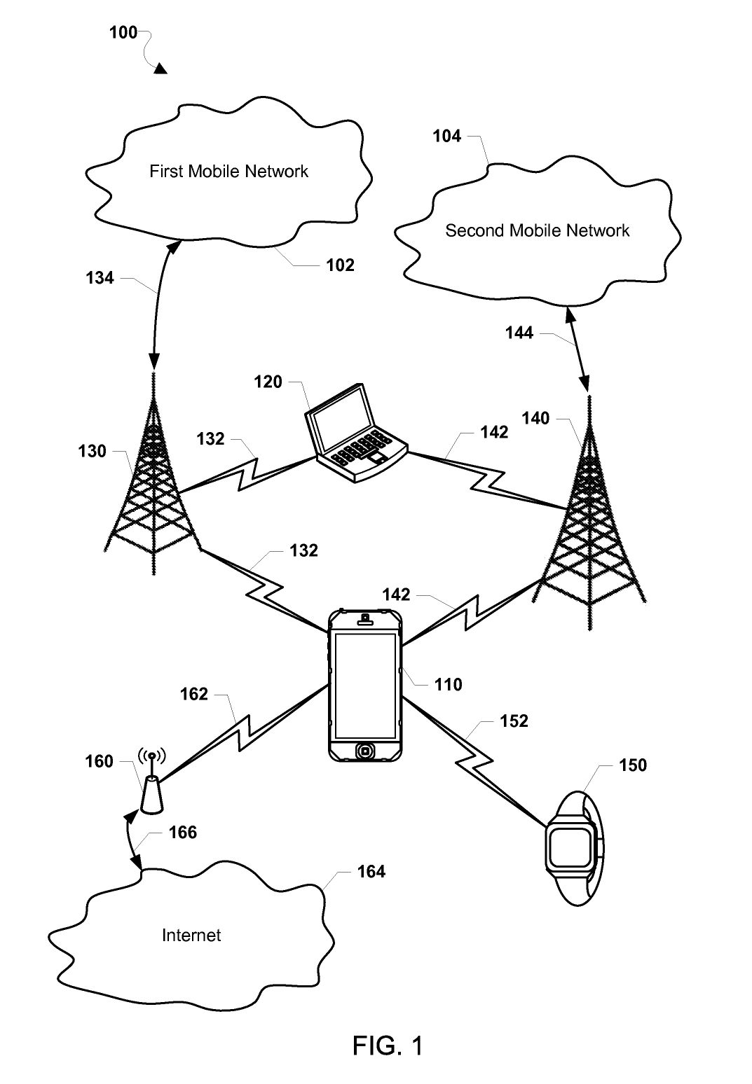

Various embodiments may be implemented within a variety of communication systems 100 that include at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may communicate with the second mobile network 104 through the cellular connection 142 to the second base station 140. The cellular connections 132 and 142 may be made through two-way wireless communication links, such as 4G, 3G, CDMA, TDMA, WCDMA, GSM, and other mobile telephony communication technologies.

While the mobile communication devices 110, 120 are shown connected to the mobile networks 102, 104, in some embodiments (not shown), the mobile communication devices 110, 120 may include two or more subscriptions to two or more mobile networks 102, 104 and may connect to those subscriptions in a manner similar to those described above.

In some embodiments, the first mobile communication device 110 may establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

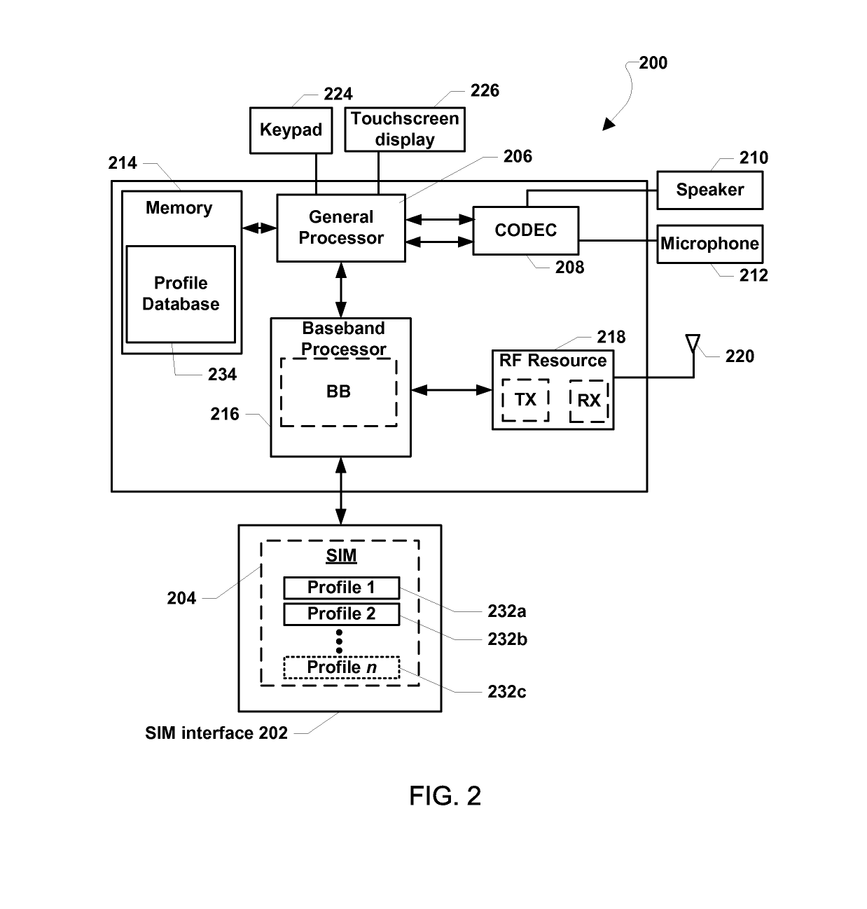

FIG. 2 is a functional block diagram of a mobile communication device 200 suitable for implementing various embodiments. According to various embodiments, the mobile communication device 200 may be similar to one or more of the mobile communication devices 110, 120 as described with reference to FIG. 1. With reference to FIGS. 1-2, the mobile communication device 200 may include a SIM interface 202, which may receive an identity module SIM 204 that is associated with a subscription.

A SIM in various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the mobile communication device 200 (e.g., memory 214), and thus need not be a separate or removable circuit, chip or card.

The mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

The memory 214, which may be non-volatile memory (e.g., FLASH memory), may store an operating system (OS), as well as user application software and executable instructions. The memory 214 may also store application data, such as an array data structure.

The general processor 206 and the memory 214 may each be coupled to at least one baseband modem processor 216. Each SIM in the mobile communication device 200 (e.g., the SIM 204) may be associated with a baseband-RF resource chain. A baseband-RF resource chain may include the baseband modem processor 216, which may perform baseband/modem functions for communicating with/controlling a RAT, and may include one or more amplifiers and radios, referred to generally herein as an RF resource 218. In some embodiments, the baseband-RF resource chains may share the baseband modem processor 216 (i.e., a single device that performs baseband/modem functions for all SIMs on the mobile communication device 200). In other embodiments, each baseband-RF resource chain may include one or more physically or logically separate baseband processors (e.g., BB).

The RF resource 218 may be a transceiver that performs transmit/receive functions on behalf of its respective radio access technology (e.g., GSM, WCDMA, etc.). The RF resource 218 may also include separate transmit and receive circuitry, or may include a transceiver that combines transmitter and receiver functions. The RF resource 218 may be coupled to a wireless antenna (e.g., a wireless antenna 220). The RF resource 218 may also be coupled to the baseband modem processor 216.

In some embodiments, the general processor 206, the memory 214, the baseband processor(s) 216, and the RF resource 218 may be included in the mobile communication device 200 as a system-on-chip. In some embodiments, the SIM 204 and its corresponding interface 202 may be external to the system-on-chip. Further, various input and output devices may be coupled to components on the system-on-chip, such as interfaces or controllers. Example user input components suitable for use in the mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the mobile communication device 200 to enable communication between them, as is known in the art.

Functioning together, the SIM 204, the baseband modem processor 216, the RF resource 218, and the wireless antenna 220 may constitute a radio access technology (“RAT”). For example, a SIM, baseband processor and RF resource may be configured to support two different radio access technologies, such as GSM and WCDMA. More RATs may be supported on the mobile communication device 200 by adding more SIM cards, SIM interfaces, RF resources, and antennae for connecting to additional mobile networks.

In various embodiments, the SIM 204 may include or utilize two or more profiles (e.g., profiles 232a-232c). Each profile may be associated with particular service information used to enable the mobile communication device 200 to receive service from a mobile network (e.g., the first mobile network 102 or the second mobile network 104) or camp on a particular cell. For example, a profile may be associated with information that identifies the user of the mobile communication device 200, identifies a particular service subscription associated with the mobile communication device 200, and/or includes information needed to communicate with, receive service from, and/or camp on one or more mobile networks (e.g., IMSIs, PLMN codes, etc.). For example, the mobile communication device 200 may utilize information associated with a first profile 232a to receive service from the first mobile network 102 and may reference information associated with a second profile 232b to acquire service from the second mobile network 104.

To communicate with/receive service from a particular mobile network, the mobile communication device 200 may access service information of a profile associated with that mobile network and may perform scans of neighboring cells to identify that particular mobile network using the profile's service information. The mobile communication device 200 may also access at least one other mobile network by switching to another profile associated with that other mobile network.

In conventional mobile communication devices that support multiple profiles, switching profiles typically involves deactivating a first profile and initializing a second profile from scratch, which requires the mobile communication device to identify the second profile's associated mobile network, perform background scans for nearby cells in that mobile network, and resolve various types of data needed to camp on and/or receive service from that mobile network. Because no information is gathered in anticipation of the switch, switching profiles on conventional mobile communication devices usually takes a substantial amount of time, during which time mobile communication devices may suffer from limited or no service.

In some embodiments, the mobile communication device 200 may be configured to store a profile database 234 within memory (e.g., the memory 214) of the device (versus within the SIM memory). The profile database 234 may be stored/maintained in non-volatile memory (e.g., the memory 214) or in volatile memory (not shown). The profile database 234 may store service information associated with each of the two or more profiles 232a-232c and/or other information that may enable the mobile communication device 200 to camp on/receive service from a mobile network. For example, the profile database 234 may store the IMSIs, PLMNs, and other camping information for each of the profiles 232a-232c. By storing this information in the profile database 234, the mobile communication device 200 may be able to switch between profiles faster than currently possible because much of the information needed to initialize a new profile is already stored in the profile database. In other words, rather than needing to identify a new profile's mobile network, perform background scans to detect available networks or to identify the correct band frequencies needed to communicate with the profile's mobile network, etc., the mobile communication device 200 may retrieve those types of information from the profile database 234 during the switch, resulting in shorter profile switches.

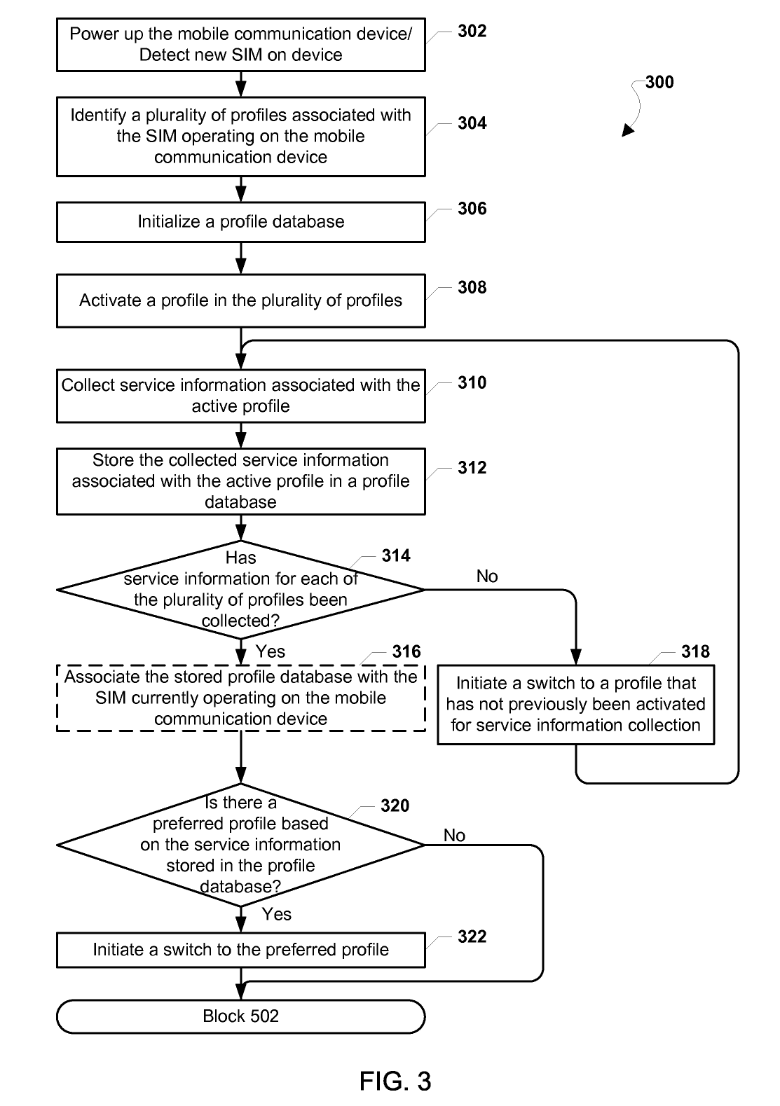

FIG. 3 illustrates a method 300 for generating a profile database (e.g., 234 in FIG. 2) with a processor (e.g., the general processor 206 in FIG. 2, the baseband modem processor 216, a separate controller, and/or the like) executing on a mobile communication device (e.g., the mobile communication device 200 described above with reference to FIG. 2) to reduce the time needed to switch between a plurality of profiles associated with a SIM on the mobile communication device.

With reference to FIGS. 1-3, the device processor may begin performing operations of the method 300 in response to the mobile communication device powering on in block 302. In some embodiments, the device processor may also begin performing the operations of the method 300 in response to detecting that a new SIM has been inserted into the mobile communication device.

In block 304, the device processor may identify a plurality of profiles associated with a SIM installed in the mobile communication device, such as by using conventional SIM-detection methods. For example, the mobile communication device may determine that the SIM currently installed in mobile communication device is associated with a first profile for receiving service from a first network (e.g., a GSM network) and a second profile for receiving service from a second network (e.g., WCDMA network).

In block 306, the device processor may initialize a profile database (e.g., the profile database 234), such as by freeing up a certain amount of space in memory and building data structures for managing service information for each of the plurality of profiles. In the above example, the device processor may initialize the profile database by generating data tables and/or data structures that are ready to store service information for the first profile and service information for the second profile.

The device processor may activate a profile in the plurality of profiles, in block 308. In some embodiments, the device processor may initially select a profile that has been pre-designated as the primary or “default” profile. For example, the mobile communication device may have previously received a user input specifying that the first profile and its GSM network is the user's primary or preferred network as the first profile may be associated with the user's “home” network, whereas the second profile may be associated with the user's “roaming” network. In some embodiments, the primary or initial profile may be set by a manufacturer of the SIM or set during the manufacture process.

In some embodiments, the device profile may activate a profile by loading relevant information associated with the active profile and needed to communicate with the active profile's mobile network. For example, the device processor may identify the PLMNs and/or other networks associated with the active profile in order to communicate with and receive service from those mobile networks.

In block 310, the device processor may collect service information associated with the profile activated in block 308, such as by reading content from the active profile. Specifically, in some embodiments, the device processor may collect information regarding the active profile's PLMNs, forbidden PLMNs, service provider names (SPNs), the names of the mobile networks associated with the profile (e.g., AT&T, T-Mobile, etc.), and various other information the mobile communication device may use when attempting to camp on a cell in a mobile network associated with the active profile. In other words, the device processor may collect all relevant information that is generated or determined during the profile's activation and/or associated with communicating with the profile's mobile network during the activation process.

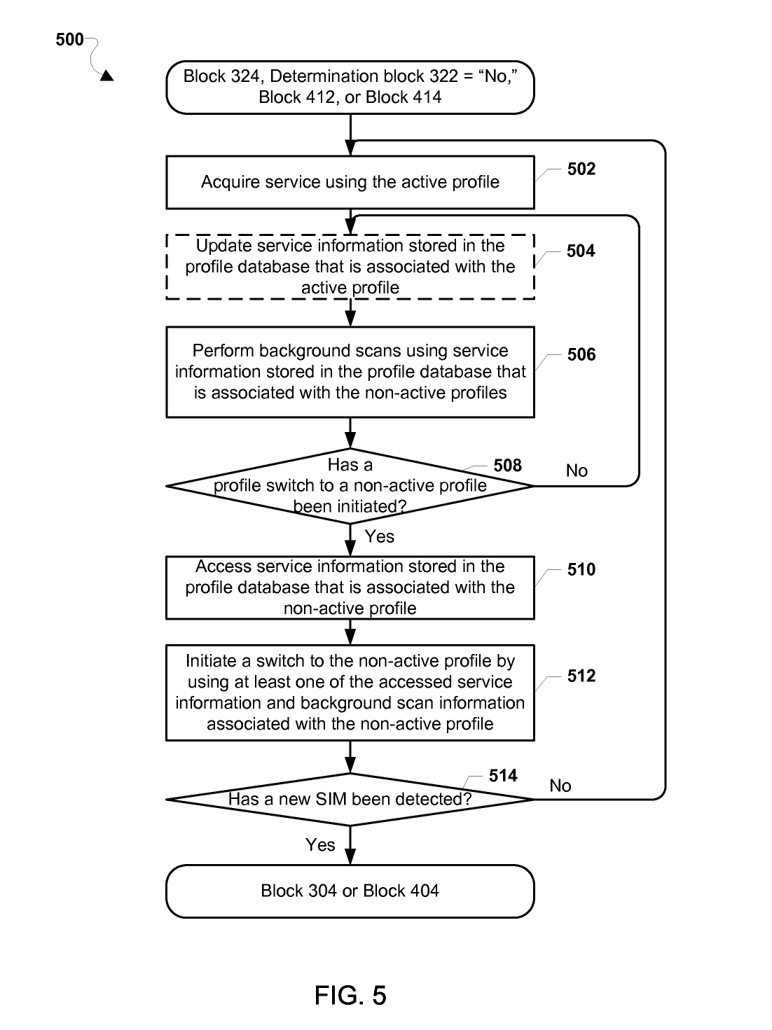

In block 312, the device processor may store the collected service information that is associated with the active profile initialized in block 306 in the profile database in the device's memory, such as non-volatile memory (e.g., 214). By storing the collected service information of the active profile in the profile database maintained in the device's memory, the device processor may be able to access the various types of highly relevant information related to the profile and the profile's mobile network at a later time without having to perform some or all of the initial activation process or otherwise accessing the SIM as further described in the disclosure. In some embodiments, the device processor may access the service information stored in the profile database that is associated with a second profile when performing an internal profile switch from a first profile to the second profile (e.g., as described with reference to FIG. 5). In some embodiments, the device processor may also utilize the information stored in the profile database that is associated with inactive profiles to perform background scans for those inactive profiles to enable a switch to one of those inactive profiles to be accomplished quickly (e.g., as described with reference to FIG. 5).

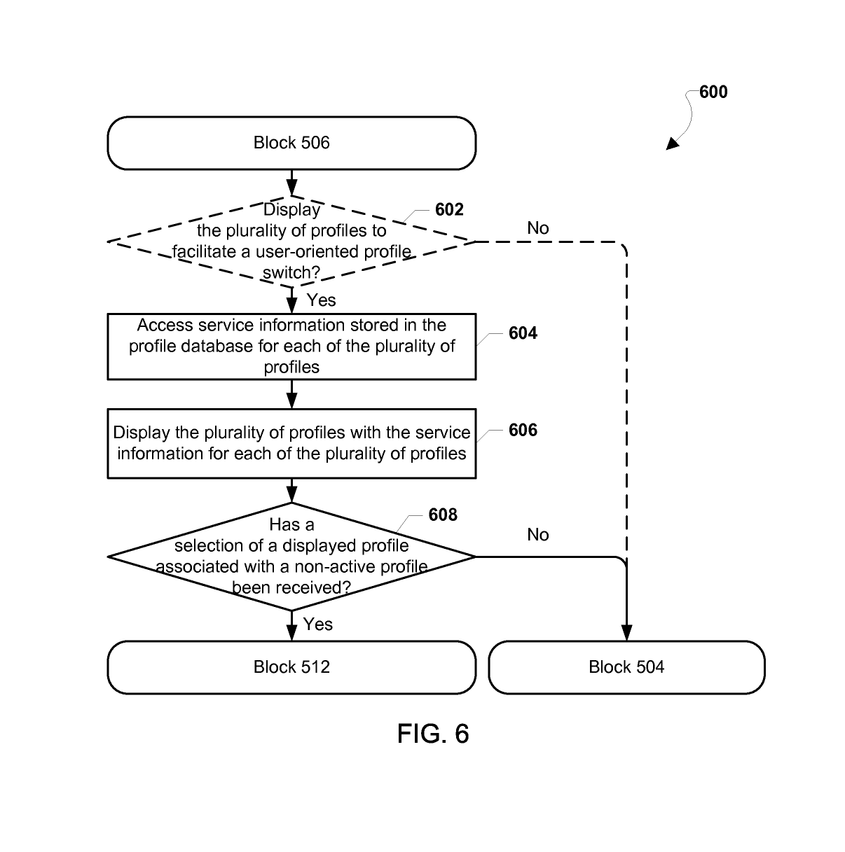

In some embodiments (e.g., as described with reference to FIG. 6), the device processor may generate a display on the mobile communication device display screen that displays information related to each of the plurality of profiles to enable a user to initiate a profile switch with the benefit of knowing information relevant to each profile, such as the profiles' associated networks (e.g., AT&T, T-Mobile, etc.) or the type of service associated with each profile (e.g., a domestic “home” network versus a foreign “roaming” network).

In determination block 314, the device processor may determine whether service information for each of the plurality of profiles has been collected. In other words, the device processor may activate each of the plurality of profiles, collect service information for each profile, and store the collected service information associated with each profile in the profile database for later use, such as when initiating internal switches between profiles, when conducting background scans of inactive profiles, and/or when displaying information for each of the profiles to the user.

In response to determining that service information for each of the plurality of profiles has not been collected (i.e., determination block 314 =“No”), the device processor may initiate an internal switch to a profile that is not previously been activated for service information collection in block 318. For example, in response to collecting and storing service information associated with a first profile, the device processor may deactivate the first profile and switch to/activate a second profile, and collect and store service information associated with the second profile in blocks 310-312.

In response to determining that service information has been collected for each of the plurality of profiles (i.e., determination block 314=“Yes”), the device processor may optionally associate the profile database with the SIM that is currently installed in the mobile communication device in optional block 316. In some embodiments, by associating the profile database with the current SIM in optional block 316, the device processor may be able to load the profile database from memory at a later time when the SIM associated with that database is inserted or after the mobile communication device is power cycled. In other words, by storing the profile database in memory, the device processor may retrieve the service information associated with the plurality of profiles associated with that SIM without having to generate the profile database from scratch, thereby avoiding the time and power required to build the profile database and collect the service information for each profile.

In determination block 320, the device processor may determine whether there is a preferred profile in the plurality of profiles based on the service information stored in the profile database. For example, in response to collecting information for each of the profiles, the device processor may determine whether any profile is associated with a primary or “default” profile (e.g., as described with reference to block 308). In some embodiments, the device processor may determine whether there is a preferred profile based on information stored in the profile database related to the mobile communication device's configuration, previous configurations of the mobile communication device, a natural or current status of the mobile communication device, etc.

In response to determining that there is a preferred profile based on the service information stored in the profile database (i.e., determination block 320=“Yes”), the device processor may initiate a switch to the preferred profile in block 322. In some embodiments, as the service information associated with the preferred profile is already stored in the profile database, the device processor may reference this information when switching to the preferred profile, such as by determining the mobile networks, PLMNs, etc., to which the preferred profile is associated. In such embodiments, the device processor may attempt to communicate with and receive service from the preferred profile's mobile networks without having to identify and scan for those networks from scratch. The device processor may continue in block 502 of method 500 (e.g., as described with reference to FIG. 5) by acquiring service using the preferred profile.

In response to determining that there is no preferred profile based on the service information stored in the profile database (i.e., determination block 320=“No”), the device processor may acquire service using the currently activated profile (e.g., the last profile in the plurality of profiles to be activated during service information collection as described) as described below with reference to block 502 (refer to FIG. 5).

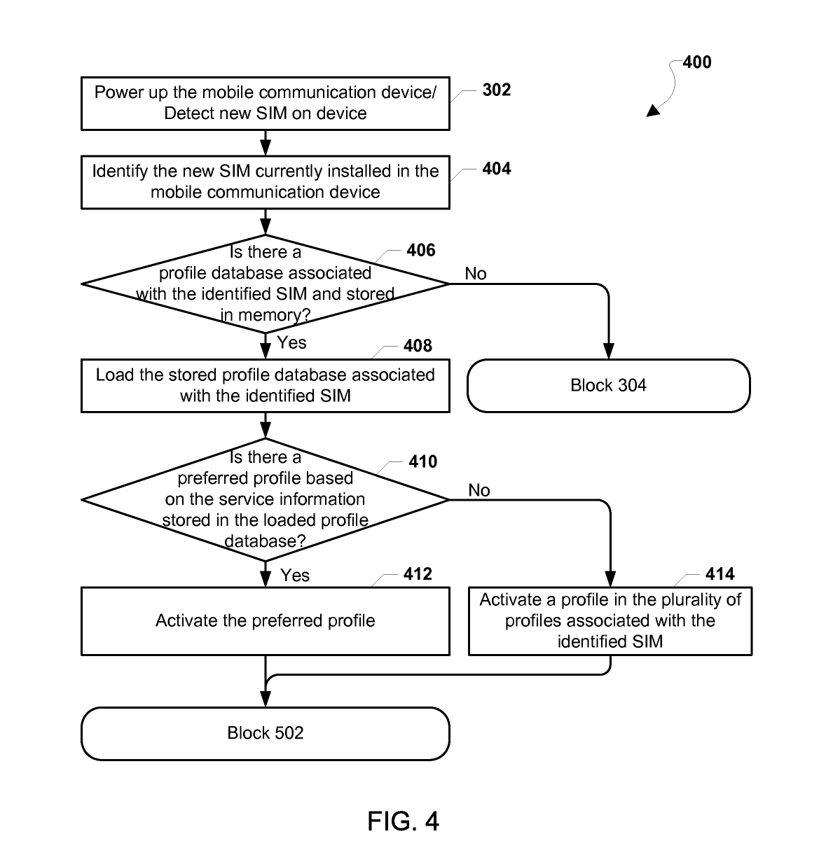

FIG. 4 illustrates a method 400 for loading a previously generated profile data with a processor (e.g., the general processor 206 in FIG. 2, the baseband modem processor 216, a separate controller, and/or the like) executing on a mobile communication device (e.g., the mobile communication device 200 described above with reference to FIG. 2). With reference to FIGS. 1-4, the device processor may begin performing operations of the method 400 in response to the mobile communication device's powering on or in response to detecting a new SIM being inserted into the mobile communication device, in block 302.

As described with reference to blocks 306, 312, and 316 of the method 300, the device processor may store profile databases that include information for a plurality of profiles associated with a particular SIM in order to quickly recall these profile databases, such as when that particular SIM is removed and reinserted at a later time or when the mobile communication undergoes a power cycle.

Thus, in block 404, the device processor may identify a new SIM that is currently installed in the mobile communication device, such as by obtaining the new SIM's integrated circuit card identifier (ICCID), IMSI, personal identification number (PIN), and/or any other type of identifying information stored in the SIM.

In determination block 406, the device processor may determine whether there is a profile database associated with the identified SIM that is stored in the device's memory. In some embodiments, as part of the operations performed in block 316 of the method 300, the device processor may associate (e.g., by IMSI) a profile database with the identified SIM that is associated with the plurality of profiles used to generate the information in the profile database.

In response to determining that there is no profile database associated with the identified SIM (i.e., determination block 406=“No”), the device processor may identify a plurality of profiles associated with the identified SIM in block 304 of the method 300. In other words, in response to determining that the currently installed SIM is not associated with a previously generated and stored profile database, the device processor may perform the operations of the method 300 in order to generate a profile database for the plurality of profiles associated with the identified SIM.

In response to determining that there is a profile database associated with the identified SIM stored in memory (i.e., determination block 406=“Yes”), the device processor may access the stored profile database associated with the identified SIM in block 408. In some embodiments, the device processor may load the stored profile database into active memory (e.g., RAM) in order to be able to quickly access the service information included in the profile database for any of the plurality of profiles associated with the identified SIM.

In determination block 410, the device processor may determine whether there is a preferred profile based on the service information stored in the profile database that the device processor accessed in block 408. Some embodiments of the operations performed in determination block 410 may be similar to the operations performed in determination block 320 of the method 300. For example, the device processor may attempt to determine whether any of the plurality of profiles has been designated as the primary or “default” profile, and/or whether the information included in the loaded profile database indicates that a particular profile is the primary profile based on the current configuration of the mobile communication device, on the current status of neighboring cells/mobile networks, etc.

In response to determining that there is no preferred profile based on the service information stored in the loaded profile database (i.e., determination block 410=“No”), the device processor may activate any one of the plurality of profiles associated with the identified SIM in block 414. In other words, since no profile is preferred, the device processor may activate any one of the plurality of profiles using various selection criteria. In response to determining that there is a preferred profile based on the service information stored in the loaded profile database (i.e., determination block 410=“Yes”), the device processor may activate the preferred profile in block 412.

Regardless of whether the device processor determines that there is a preferred profile in determination block 410, in response to activating a profile in block 412 or block 414, the device processor may acquire service with the active profile (e.g., the preferred profile or any one profile) in block 502 (refer to FIG. 5).

FIG. 5 illustrates a method 500 that may be implemented by a processor (e.g., the general processor 206 in FIG. 2, the baseband modem processor 216, a separate controller, and/or the like) executing on a mobile communication device (e.g., the mobile communication device 200 described above with reference to FIG. 2) for utilizing the information stored in a profile database to facilitate efficient internal switching between profiles. Thus, with reference to FIGS. 1-5, the device processor may begin performing operations of the method 500 in response to initiating a switch to a preferred profile in block 322, to determining that there is no preferred profile (i.e., determination block 320 =“No”), to activating a preferred profile in block 412, or to activating any one profile in the plurality of profiles in block 414.

In block 502, the device processor may acquire service using the currently active profile. In some embodiments, the device processor may access service information stored in the profile database that is associated with the active profile to discover the mobile networks, frequency bands, neighboring cells, and/or other information that may be necessary to identify, communicate with and receive service from a mobile network associated with the active profile. For example, the device processor may perform a lookup in the profile database to identify the particular PLMN associated with the active profile and may attempt to acquire service using that PLMN.

In optional block 504, the device processor may optionally update the service information stored in the profile database that is associated with the active profile. In some embodiments, in response to acquiring service using the active profile, the device processor may continually access new or “fresh” information that may better enable the device processor to acquire service with the active profile. For example, the list of viable neighboring cells to connect to the active profile's (e.g., a first profile's) network may change based on location. The device processor may identify these changes and may update/replace old or “stale” service information associated with the first profile in the profile database with this new information. Thus, the device processor may access this updated information for the first profile when switching back to the first profile from a second profile at a later time.

In block 506, the device processor may perform background scans using service information stored in the profile database that is associated with non-active profiles. As described, in conventional mobile communication devices, in order to switch profiles from a first profile to a second profile, as part of activating the second profile, the devices must perform several operations to identify the networks associated with the second profile and then attempt to find those networks by performing scanning operations.

In contrast, in some embodiments of the disclosure, the device processor may utilize service information in the profile database that is associated with the one or more non-active profiles in the plurality of profiles to perform background scans before a profile switch is initiated. Specifically, in some embodiments, for each non-active profile, the device processor may access information in the profile database stored in the device's memory that identifies the PLMNs, mobile networks, and/or other information needed to acquire service with the non-active profile. For example, the device processor may learn that a particular non-active profile is associated with a certain PLMN and may monitor that PLMN, enabling the device processor to quickly and precisely acquire service for the non-active profile via that PLMN in the event a switch to that non-active profile is initiated.

In determination block 508, the device processor may determine whether a profile switch to a non-active profile has been initiated. In some embodiments, the device processor may monitor for situations in which switching profiles may be appropriate, such as when the mobile communication device enters a new location that may provide better service for a non-active profile (e.g., entering a “roaming” network). In some embodiments, the device processor may monitor for a user selection that indicates the user's desire to switch from the active profile to a different, non-active profile (e.g., as described with reference to FIG. 6).

In response to determining that a profile switch to a non-active profile has not been initiated (i.e., determination block 508=“No”), the device processor may repeat the above operations in optional block 504 by updating service information stored in the profile database that is associated with the active profile. In other words, the device processor may repeat the operations of blocks 504, 506 until a profile switch is initiated.

In response to determining that a profile switch to a non-active profile has been initiated (i.e., determination block 508=“Yes”), the device processor may access service information stored in the profile database that is associated with that particular non-active profile in block 510. In some embodiments, the device processor may access service information stored in the profile database pertaining to the non-active profile's preferred networks, PLMNs, IMSI, and other service information needed to acquire service with the non-active profile's mobile networks.

In block 512, the device processor may initiate a switch to the non-active profile by using at least one of the service information accessed in block 510 and the background scan information that is associated with the non-active profile and obtained as a result of performing the operations in block 506. In other words, the device processor may utilize the information stored in the profile database and/or the background scan information for the non-active profile to active and to begin acquiring service for the non-active profile.

In determination block 514, the device processor may determine whether a new SIM has been detected on the mobile communication device. For example, the device processor may receive a signal from a SIM interface (e.g., the SIM interface 202) indicating that a SIM previously installed on the mobile communication device has been replaced by a new SIM.

In response to detecting that a new SIM has been installed (i.e., determination block 514=“Yes”), the device processor may repeat the above operations of the method 300 by identifying a plurality of profiles associated with the new SIM in block 304, or the device processor may repeat the operations of the method 400 by identifying the new SIM in block 404 to determine whether there is a pre-generated profile database stored in memory that is associated with the new SIM (i.e., determination block 406). Thus, in some embodiments, the device processor may quickly and dynamically generate or recall profile databases for multiple SIMs.

In response to determining that a new SIM has not been detected (i.e., determination block 514=“No”), the device processor may repeat the operations of the method 500 by acquiring service using the newly activated profile in block 502.

FIG. 6 illustrates a method 600 that may be implemented by a processor (e.g., the general processor 206 in FIG. 2, the baseband modem processor 216, a separate controller, and/or the like) executing on a mobile communication device (e.g., the mobile communication device 200 described above with reference to FIG. 2) for displaying the information stored in a profile database to a user to facilitate a user-oriented profile switch. The operations of the method 600 implement embodiments of the operations in determination block 508. Thus, with reference to FIGS. 1-6, the device processor may begin performing operations of the method 600 after performing background scans of the non-active profiles stored in the profile database in block 506.

In optional determination block 602, the processor device may determine whether to display the plurality of profiles to facilitate a user-oriented profile switch.

In some embodiments, the mobile communication device may receive a user input (e.g., via the keyboard 224, the touchscreen display 226, and/or via various other user interface devices) that indicates that the user may be interested in switching profiles. For example, the device processor may receive a signal indicating that a user input is requesting a display of the each of the plurality of profiles associated with the SIM currently installed in the mobile communication device.

In response to determining not to display the plurality of profiles (i.e., determination block 602=“No”), the device processor may continue in block 504 of the method 500 by optionally updating service information stored in the profile database that is associated with the active profile.

In response to determining to display the plurality of profiles (i.e., determination block 602=“Yes”), the device processor may access service information stored in the profile database for each of the plurality of profiles in block 604. In some embodiments, the device processor may obtain information that may be particularly relevant to a user's decision to initiate a profile switch, such as the name of the network associated with each profile, the quality of service that is expected on each profile's network based on information obtained through background scanning, the type of service associated with each profile, etc.

In block 606, the device processor may display the plurality of profiles, along with the service information gathered for each profile in block 604. In some embodiments of the operations performed in block 606, the device processor may cause the mobile communication device's display to list each of the plurality of profiles associated with the SIM currently installed in the device, along with the particularly relevant or helpful information as described gathered as a result of performing the operations in block 604.

In determination block 608, the device processor may determine whether a selection of a displayed profile associated with a non-active profile has been received. In other words, the device processor may monitor for a user-oriented input indicating the user's desire to switch from the current, active profile to a non-active profile.

In response to determining that a selection of a displayed profile associated with a non-active profile has not been received (i.e., determination block 608=“No”), the device processor may optionally updating service information stored in the profile database that is associated with the active profile in block 504 of the method 500 as described.

In response to determining that a selection of a displayed profile associated with a non-active profile has been received (i.e., determination block 608=“Yes”), the device processor may access service information stored in the profile database that is associated with the selected non-active profile continue in block 510 of method 500.

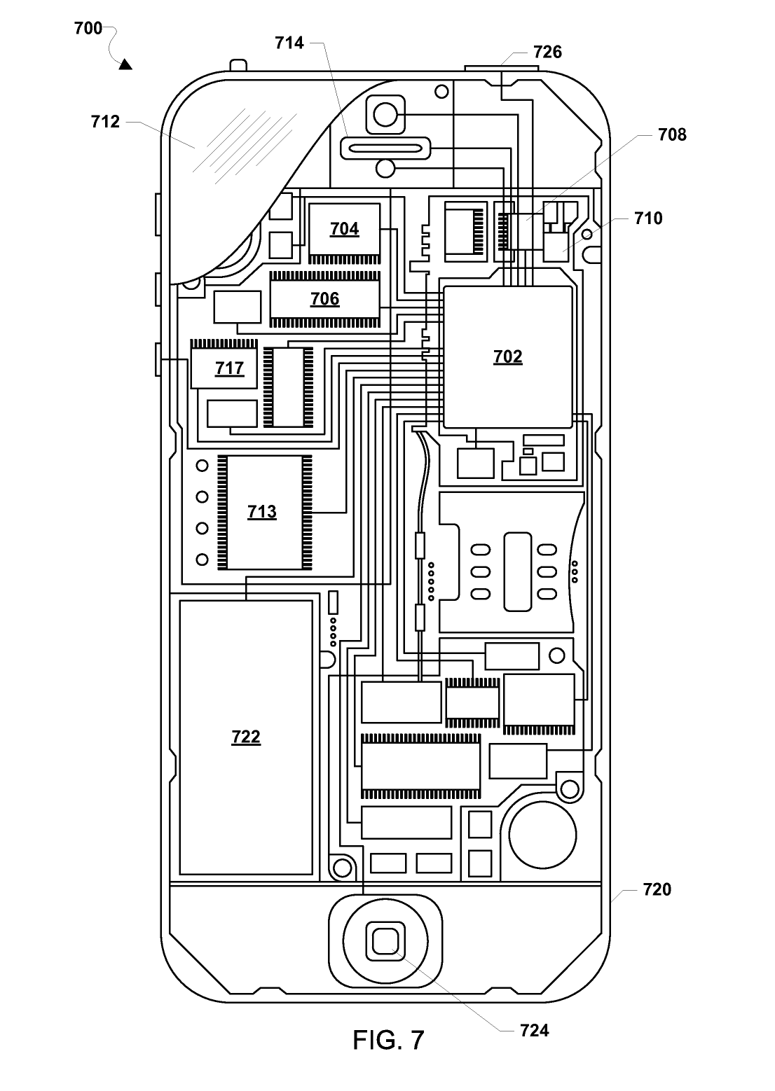

Various embodiments may be implemented in any of a variety of mobile communication devices, an example on which (e.g., mobile communication device 700) is illustrated in FIG. 7. According to various embodiments, the mobile communication device 700 may be similar to the mobile communication devices 110, 120, 200 as described above with reference to FIGS. 1-2. As such, the mobile communication device 700 may implement the methods 300, 400, 500, and 600 of FIGS. 3-6.

With reference to FIGS. 1-7, the mobile communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the mobile communication device 700 need not have touch screen capability.

The mobile communication device 700 may have one or more cellular network transceiver (e.g., cellular network transceiver 708) coupled to the processor 702 and one or more antennae (e.g., wireless antenna 710) and configured for sending and receiving cellular communications. The transceiver 708 and the wireless antenna 710 may be used with the above-mentioned circuitry to implement the various embodiment methods. The mobile communication device 700 may one or more SIM cards (e.g., SIM card 713) coupled to the transceiver 708 and/or the processor 702 and configured as described above. The mobile communication device 700 may include a cellular network wireless modem chip 717 that enables communication via a cellular network and is coupled to the processor 702.

The mobile communication device 700 may also include speakers 714 for providing audio outputs. The mobile communication device 700 may also include a housing 720, constructed of a plastic, metal, or a combination of materials, for containing all or some of the components discussed herein. The mobile communication device 700 may include a power source 722 coupled to the processor 702, such as a disposable or rechargeable battery. The rechargeable battery may also be coupled to the peripheral device connection port to receive a charging current from a source external to the mobile communication device 700. The mobile communication device 700 may also include a physical button 724 for receiving user inputs. The mobile communication device 700 may also include a power button 726 for turning the mobile communication device 700 on and off

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing service information for a plurality of profiles associated with a Subscriber Identity Module (SIM) on a mobile communication device, comprising:
initializing a first profile database stored in memory of the mobile communication device;
activating and collecting service information for each of the plurality of profiles; and
storing collected service information associated with each of the plurality of profiles in the first profile database.

2. The method of claim 1, further comprising:
associating the first profile database with the SIM on the mobile communication device.

3. The method of claim 1, further comprising:
determining whether there is a preferred profile in the plurality of profiles based on the collected service information in the first profile database; and
initiating a switch to the preferred profile from an active profile in response to determining the preferred profile is in the plurality of profiles based on the collected service information stored in the first profile database.

4. The method of claim 1, further comprising:
detecting when a new SIM is installed in the mobile communication device;
determining whether there is a profile database associated with the new SIM that is stored in the memory of the mobile communication device; and
loading the stored profile database associated with the new SIM in response to determining that the profile database associated with the new SIM is stored in the memory of the mobile communication device.

5. The method of claim 4, further comprising:
initializing a second profile database in response to determining that there is no profile database associated with the new SIM that is stored in the memory of the mobile communication device;
identifying a plurality of profiles associated with the new SIM;
activating and collecting service information for each of the plurality of profiles associated with the new SIM; and
storing the collected service information associated with each of the plurality of profiles associated with the new SIM in the second profile database in the memory of the mobile communication device.

6. The method of claim 1, further comprising:
acquiring service using an active profile in the plurality of profiles;
determining whether a profile switch from the active profile to a non-active profile has been initiated;
accessing service information associated with the non-active profile that is stored in the first profile database in response to determining that a profile switch from the active profile to the non-active profile has been initiated; and
initiating a switch to the non-active profile from the active profile by using the accessed service information associated with the non-active profile.

7. The method of claim 6, further comprising updating service information associated with the active profile that is stored in the first profile database stored in the memory of the mobile communication device.

8. The method of claim 6, wherein:
the method further comprises performing background scans for the non-active profile to obtain background scan information associated with the non-active profile; and
initiating a switch to the non-active profile from the active profile by using the accessed service information associated with the non-active profile comprises initiating the switch to the non-active profile from the active profile by using at least one of the accessed service information associated with the non-active profile and the background scan information associated with the non-active profile.

9. The method of claim 6, wherein determining whether a profile switch from the active profile to a non-active profile has been initiated comprises:
accessing service information included in the first profile database for each of the plurality of profiles;
displaying the plurality of profiles with the service information for each of the plurality of profiles;
determining whether a selection of a displayed profile associated with a non-active profile in the plurality of profiles has been received;
accessing service information associated with the selected non-active profile from the first profile database stored in the memory of the mobile communication device; and
initiating a switch from the active profile to the selected non-active profile by using the accessed service information associated with the selected non-active profile.

10. The method of claim 1, wherein the service information includes at least one of an international mobile subscriber identity, an allowed public land mobile network, a forbidden public land mobile network, a service provider name, a mobile network name, a neighboring cell, a frequency band, and service agreement information.

11. A mobile communication device, comprising:
a memory; and
a processor coupled to the memory, configured to connect to a Subscriber Identity Module (SIM), and configured with processor-executable instructions to:
initialize a first profile database stored in the memory of the mobile communication device;
activate and collect service information for each of a plurality of profiles associated with the SIM; and
store collected service information associated with each of the plurality of profiles in the first profile database.

12. The mobile communication device of claim 11, wherein the processor is further configured with processor-executable instructions to:
associate the first profile database with the SIM on the mobile communication device.

13. The mobile communication device of claim 11, wherein the processor is further configured with processor-executable instructions to:
determine whether there is a preferred profile in the plurality of profiles based on the collected service information in the first profile database; and
initiate a switch to the preferred profile from an active profile in response to determining that the preferred profile is in the plurality of profiles based on the collected service information stored in the first profile database.

14. The mobile communication device of claim 11, wherein the processor is further configured with processor-executable instructions to:
detect that a new SIM is installed in the mobile communication device;
determine whether there is a profile database associated with the new SIM that is stored in the memory of the mobile communication device; and
load the stored profile database associated with the new SIM in response to determining that the profile database associated with the new SIM is stored in the memory of the mobile communication device.

15. The mobile communication device of claim 14, wherein the processor is further configured with processor-executable instructions to:
initialize a second profile database in response to determining that there is no profile database associated with the new SIM that is stored in the memory of the mobile communication device;
identify a plurality of profiles associated with the new SIM;
activate and collecting service information for each of the plurality of profiles associated with the new SIM; and
store the collected service information associated with each of the plurality of profiles associated with the new SIM in the second profile database in the memory of the mobile communication device.

16. The mobile communication device of claim 11, wherein the processor is further configured with processor-executable instructions to:
acquire service using an active profile in the plurality of profiles;
determine whether a profile switch from the active profile to a non-active profile has been initiated;
access service information associated with the non-active profile that is stored in the first profile database in response to determining that a profile switch from the active profile to the non-active profile has been initiated; and
initiate a switch to the non-active profile from the active profile by using accessed service information associated with the non-active profile.

17. The mobile communication device of claim 16, wherein the processor is further configured with processor-executable instructions to:
update service information associated with the active profile that is stored in the first profile database stored in the memory of the mobile communication device.

18. The mobile communication device of claim 16, wherein the processor is further configured with processor-executable instructions to:
perform background scans for the non-active profile to obtain background scan information associated with the non-active profile; and
wherein the processor is further configured with processor-executable instructions to initiate a switch to the non-active profile from the active profile by using the accessed service information associated with the non-active profile by initiating the switch to the non-active profile from the active profile by using at least one of the accessed service information associated with the non-active profile and the background scan information associated with the non-active profile.

19. The mobile communication device of claim 16, wherein the processor is configured with processor-executable instructions to determine whether a profile switch from the active profile to a non-active profile has been initiated by:
accessing service information included in the first profile database for each of the plurality of profiles;
displaying the plurality of profiles with the service information for each of the plurality of profiles;
determining whether a selection of a displayed profile associated with a non-active profile in the plurality of profiles has been received;
accessing service information associated with the selected non-active profile from the first profile database stored in the memory of the mobile communication device; and
initiating a switch from the active profile to the selected non-active profile by using the accessed service information associated with the selected non-active profile.

20. The mobile communication device of claim 11, wherein the service information includes at least one of an international mobile subscriber identity, an allowed public land mobile network, a forbidden public land mobile network, a service provider name, a mobile network name, a neighboring cell, a frequency band, and service agreement information.

21. A non-transitory processor-readable storage medium having stored thereon processor-executable instructions configured to cause a processor of a mobile communication device to perform operations comprising:
initializing a first profile database stored in memory;
activating and collecting service information for each of a plurality of profiles associated with a Subscriber Identity Module (SIM) installed in the mobile communication device; and
storing collected service information associated with each of the plurality of profiles in the first profile database.

22. The non-transitory processor-readable storage medium of claim 21, wherein the processor-executable instructions are further configured to cause a processor of a mobile communication device to perform operations comprising:
associating the first profile database with the SIM on the mobile communication device.

23. The non-transitory processor-readable storage medium of claim 21, wherein the processor-executable instructions are further configured to cause a processor of a mobile communication device to perform operations comprising:
determining whether there is a preferred profile in the plurality of profiles based on the collected service information in the first profile database; and
initiating a switch to the preferred profile from an active profile in response to determining the preferred profile is in the plurality of profiles based on the collected service information stored in the first profile database.

24. The non-transitory processor-readable storage medium of claim 21, wherein the processor-executable instructions are further configured to cause a processor of a mobile communication device to perform operations comprising:
detecting when a new SIM is installed in the mobile communication device;
determining whether there is a profile database associated with the new SIM that is stored in the memory of the mobile communication device; and
loading the stored profile database associated with the new SIM in response to determining that the profile database associated with the new SIM is stored in the memory of the mobile communication device.

25. The non-transitory processor-readable storage medium of claim 24, wherein the processor-executable instructions are further configured to cause a processor of a mobile communication device to perform operations comprising:
initializing a second profile database in response to determining that there is no profile database associated with the new SIM that is stored in the memory of the mobile communication device;
identifying a plurality of profiles associated with the new SIM;
activating and collecting service information for each of the plurality of profiles associated with the new SIM; and
storing the collected service information associated with each of the plurality of profiles associated with the new SIM in the second profile database in the memory of the mobile communication device.

26. The non-transitory processor-readable storage medium of claim 21, wherein the processor-executable instructions are further configured to cause a processor of a mobile communication device to perform operations comprising:
acquiring service using an active profile in the plurality of profiles;
determining whether a profile switch from the active profile to a non-active profile has been initiated;
accessing service information associated with the non-active profile that is stored in the first profile database in response to determining that a profile switch from the active profile to the non-active profile has been initiated; and
initiating a switch to the non-active profile from the active profile by using the accessed service information associated with the non-active profile.

27. The non-transitory processor-readable storage medium of claim 26, wherein the processor-executable instructions are further configured to cause a processor of a mobile communication device to perform operations comprising:
updating service information associated with the active profile that is stored in the first profile database stored in the memory of the mobile communication device.

28. The non-transitory processor-readable storage medium of claim 26, wherein the processor-executable instructions are further configured to cause a processor of a mobile communication device to perform operations comprising:
performing background scans for the non-active profile to obtain background scan information associated with the non-active profile; and
wherein the processor-executable instructions are further configured to cause a processor of a mobile communication device to perform operations comprising initiating a switch to the non-active profile from the active profile by using the accessed service information associated with the non-active profile by initiating the switch to the non-active profile from the active profile by using at least one of the accessed service information associated with the non-active profile and the background scan information associated with the non-active profile.

29. The non-transitory processor-readable storage medium of claim 26, wherein the processor-executable instructions are further configured to cause a processor of a mobile communication device to perform operations comprising determining whether a profile switch from the active profile to a non-active profile has been initiated by:
accessing service information included in the first profile database for each of the plurality of profiles;
displaying the plurality of profiles with the service information for each of the plurality of profiles;
determining whether a selection of a displayed profile associated with a non-active profile in the plurality of profiles has been received;
accessing service information associated with the selected non-active profile from the first profile database stored in the memory of the mobile communication device; and
initiating a switch from the active profile to the selected non-active profile by using the accessed service information associated with the selected non-active profile.

30. A mobile communication device, comprising:
means for initializing a first profile database stored in memory;
means for activating and collecting service information for each of a plurality of profiles associated with a Subscriber Identity Module (SIM) installed in the mobile communication device; and
means for storing collected service information associated with each of the plurality of profiles in the first profile database.
